(19) United States
(12) Patent Application Publication
(10) Pub. No.: US 2006/0000786 A1
(43) Pub. Date: Jan. 5, 2006

(54) Filtering screen construction and methods

(76) Inventors: Ruediger Tueshaus, Dorsten (DE); Patrick McGrenera, The Woodlands, TX (US)

Correspondence Address: KENNETH L. NASH, P.O. BOX 680106, HOUSTON, TX, 77268-0106, US

(21) Appl. No.: 11/221,051

(22) Filed: Sep. 7, 2005

Related U.S. Application Data
(63) Continuation of application No. 10/157,537, filed on May 29, 2002.

(51) Int. Cl. B01D 29/01

(52) U.S. Cl. 210/767; 210/499

(57) ABSTRACT

An assembly and method is provided for a screen that may be utilized for filtering purposes including filtering drilling fluid in a vibrating shaker. In a preferred embodiment, at least one screen is formed of a plurality of planar wires that are woven together with a plurality of wires, which may or may not also be planar to thereby reduce the friction forces produced by the so-constructed screen. The screen formed with planar wires may be used by itself or in conjunction with other screens to produce a screen assembly that is resistant to vibration damage. The screen formed with planar wires may also be utilized to provide improved filtration performance by itself or in combination with other screens by offering a more precise opening at the initial point of contact therefore improving the de-binding function of the screen.

### TECHNICAL FIELD

The present invention relates generally to vibratory and/or filtering screens and, more specifically, to assemblies and methods utilizing woven planar surfaced wires therein.

### BACKGROUND

Vibratory and/or filtering screens are well known in the art and may be used for various filtering purpose such as, for instance, for filtering fluids, solids, and/or separating particles from fluids. For instance, vibratory screens are commonly utilized during mining or drilling operations. During drilling operations, drilling fluid is typically pumped into the drill pipe, through the drill bit, and then back to the surface in the annulus between the drill pipe and the wellbore. The drilling fluid performs numerous important functions, one of which is to remove the drilling cuttings, formation materials, and debris from the wellbore. The drilling fluid is quite expensive and therefore it is desirable to filter the wellbore materials from the drilling fluid so the same drilling fluid can be used repeatedly. Thus, the drilling fluid is typically continuously circulated through the wellbore as the well is drilled whereby a continuous vibratory screening process is normally utilized to clean the drilling fluid.

A vibrating screen or shaker may be utilized for filtering the drilling fluid and may typically be positioned between the flow of drilling fluid from the wellbore and the pumps. There may be several different filters operating to filter the different size particles, cuttings, materials, and so forth. In many cases, there may be different layers of vibrating screening material. One or more layers of finer materials for filtering finer particles may be supported or backed by a stronger, typically coarser, filament mesh or cloth so the fine material is better able to withstand to vibrational forces and the weight of the fluid over longer periods of time.

However, due to the continuous vibrational movement which places high stresses on the screen, prior art screen designs may frequently tear. The resulting replacement costs may even cause downtime for drilling, which is expensive. Therefore, it is highly desirable that the life time of the vibrating screen assembly be as long as possible while still performing the screening function required.

It is believed that one problem that causes such tearing and/or wear relates to the knuckles formed during the weaving process of the screen where the filaments, such as wires, which may be called warp and shute filaments, intersect by crossing under and over each other, i.e., where the wires change their relative planar position in the mesh. The knuckles of the support screen may extend upwardly to engage the finer screen to produce contact areas where friction is concentrated and is a source of wear for the finer material. The knuckles produced on round wire screens are sharply pointed due to the top center of the round wires that actually comes to a point.

In the prior art, a calendaring process has been utilized to flatten the wire mesh at the knuckles to reduce the friction caused by the knuckles of the support screen against the fine screen. During the prior art calendaring processes, the woven mesh or screen is inserted between rollers that flatten the knuckles of the intersections. However, calendaring the woven mesh or screen has several problems. The crimping of the wires together during calendaring weakens the wires at the intersections or joints. The locking of the wires together tends to reduce the filtering ability of the screen due to the reduced movement of the wires. If the flattening is too great then the wires may be so damaged that failure occurs more rapidly. Moreover, the calendaring process and/or calendaring equipment for processing the woven mesh is quite expensive thus making the cost of the screens expensive. Also, the calendaring process may change the filtering characteristics of the screen by making the open areas smaller.

Consequently, there remains a need to provide an improved filtering and/or vibratory screen and method. Those of skill in the art will appreciate the present invention which addresses the above and other problems.

### SUMMARY OF THE INVENTION

By combining the mechanical points of planar wires and certain weaving methods, such as plain weave, twill weave, dutch weave, three heddle weave, five heddle weave, in accord with the present invention, it is possible to eliminate the knuckles that cause excess friction between mesh layers and eliminate the need to calender the mesh in order to achieve a smooth flat surface. With planar flat wires the sharp point of the round wire is eliminated. As well, any undesired crimping is also eliminated although the invention permits the use of wire crimping, when desired.

An objective of the present invention is to provide an improved vibration resistant screen mesh or cloth assembly and method.

Another objective of an embodiment of this invention is to provide a screen mesh or cloth for use in pressure filters and/or vibration filters or shakers that is woven with one or more planar surfaced members such as planar surfaced filaments and/or wires.

Another objective is improved filtering by reducing blockage of the filter.

These and other objectives, features, and advantages of the present invention will become apparent from the drawings, the descriptions given herein, and the appended claims. However, it will be understood that above-listed objectives and/or advantages of the invention are intended only as an aid in quickly understanding aspects of the invention, are not intended to limit the invention in any way, and therefore do not form a comprehensive or restrictive list of objectives, and/or features, and/or advantages.

Accordingly, the invention comprises, in one embodiment thereof, a screen assembly for filtering drilling fluid. The screen assembly may comprise one or more elements such as a first plurality of planar wires that are woven with a second plurality of wires to form a first screen. Each of the planar wires may be formed prior to being woven so as to have a cross-section with one or more planar surfaces. The planar surface on the wires also preferably extends substantially uniformly along the length of each of the plurality of planar wires. In one embodiment, a screen comprised of woven planar wires may be the first screen in contact with the media to be filtered to reduce blockage of the screen.

In one presently preferred embodiment, one or more additional screens may also be secured to or with respect to the surface of the first screen to form the screen assembly for filtering the drilling fluid.

The first plurality of planar wires may be oriented within the first screen such that the planar surface of the wires forms at least a portion, and preferably a substantial portion, of the surface of the first screen.

The first plurality of planar wires and the second plurality of wires intersect to form intersections without the sharp knuckle of round wires. The first plurality of planar wires may have portions between the intersections where the planar surfaces of the first plurality of planar wires are substantially parallel to the surface of the first screen.

The second plurality of wires may also have a cross-section with a second planar surface and the second planar surfaces may also be oriented to form a substantial portion of the surface of the first screen. Alternatively, the second plurality of wires may have a round cross-section.

In one case, the first screen is mechanically stronger than the additional screen or screens and may support one or more of the additional screens. However, the first screen could also be utilized as the fine screen which is supported.

In operation, a method is provided for filtering substances wherein the method may comprise one or more steps such as, for instance, providing a first plurality of planar wires formed so as to have a cross-section with one or more planar surfaces, weaving the first plurality of planar wires with a second plurality of wires to form a first screen with a first surface, and utilizing the first screen for filtering the substances.

The method may further comprise securing the first screen with respect to one or more additional screens to form a screen assembly, and utilizing the screen assembly for filtering the substances. The method may further comprise supporting the one or more additional screens with the first screen. The method may further comprise orienting the one or more planar surfaces during the weaving such that at least a portion of the planar surfaces is oriented to form a substantial portion of the first surface.

In another embodiment, a screen filtration assembly for filtering one or more materials may comprise one or more elements such as, for instance, a first plurality of planar wires wherein the first plurality of planar wires may be formed with one or more planar surfaces substantially along their length prior to being woven. The first plurality of planar wires may be interwoven with respect to a second plurality of wires to form a first screen having a first surface with a first plurality openings therein between a plurality of intersections formed by the first plurality of planar wires and the second plurality of wires. The openings may be sized to perform a filtering function with respect to the one or more materials to be filtered.

At least one additional screen may, if desired, be mounted to the first surface of the first screen and secured thereto. The additional screen or screens is formed with a second plurality of openings and the second plurality of openings may be finer than the first plurality of openings. The first screen may be mechanically stronger than the second screen to provide a support for the second screen.

Alternatively, the second plurality of openings may be coarser than the first plurality of openings and the one or more additional screens may be mechanically stronger than the first screen to provide a support for the first screen. The first plurality of planar wires may each have a different cross-sectional shape than the second plurality of wires. On the other hand, if desired, they may also each have an identical cross-sectional shape as compared to the second plurality of wires.

This summary is not intended to be a limitation with respect to the features of the invention as claimed, and this and other objects can be more readily observed and understood in the detailed description of the preferred embodiment and in the claims.

### BRIEF DESCRIPTION OF DRAWINGS

For a further understanding of the nature and objects of the present invention, reference should be had to the following detailed description, taken in conjunction with the accompanying drawings, in which like elements are given the same or analogous reference numbers and wherein:

FIG. 1 is a perspective view showing a plain weave screen utilizing woven planar-surfaced members therein in accord with the present invention;

FIG. 2 is a perspective view showing a five-heddle weave utilizing woven planar-surfaced members therein in accord with the present invention;

FIG. 2A is an elevational side view of the five-heddle weave of planar-surfaced members shown in FIG. 2;

FIG. 3 is a perspective view showing a three-heddle weave utilizing woven planar-surfaced members therein in accord with the present invention;

FIG. 4 is an elevational view, in cross-section, showing a plurality of cross-sections of a different types of planar-surfaced members in accord with the present invention;

FIG. 5 is a perspective view showing use of a first cross-sectional shaped filament, in this case a planar surfaced filament, with a second different cross-sectional shaped filament, in this case a round filament, in accord with the present invention;

FIG. 6 is an elevational view of one possible construction of a screen having a plurality of layers in accord with the present invention;

FIG. 7 is a perspective view showing planar surfaced filaments woven with round filaments in a five-heddle weave, in accord with the present invention;

FIG. 7A is a side view of the screen or mesh of FIG. 7 showing a relatively flat surface with only slight variations;

FIG. 8 is a perspective view showing planar surfaced filaments woven with round filaments in a twilled weave, in accord with the present invention;

FIG. 8A is a side view of the screen or mesh of FIG. 8 showing how the plurality of planar wires in combination to with each other produce a composite relatively flat surface;

FIG. 9A is an elevational view illustrating filtering characteristics of round cross-section wires;

FIG. 9B is an elevational view illustrating filtering characteristics of rectangular cross-section planar wires;

FIG. 9C is an elevational view illustrating filtering characteristics of triangular cross-section planar wires;

FIG. 10 is a perspective view showing triangular cross-sectioned planar wires woven with substantially rectangular cross-sectioned planar wires;

FIG. 10A is an enlarged perspective view of the screen of FIG. 10 showing this embodiment in greater detail;

FIG. 11A is an elevational view illustrating filtering characteristics of round cross-section wires;

FIG. 11B is an elevational view illustrating filtering characteristics of rectangular cross-section planar wires; and

FIG. 11C is an elevational view illustrating filtering characteristics of triangular cross-section planar wires.

While the present invention will be described in connection with presently preferred embodiments, it will be understood that it is not intended to limit the invention to those embodiments. On the contrary, it is intended to cover all alternatives, modifications, and equivalents included within the spirit of the invention.

### GENERAL DESCRIPTION OF PREFERRED EMBODIMENTS FOR CARRYING OUT THE INVENTION

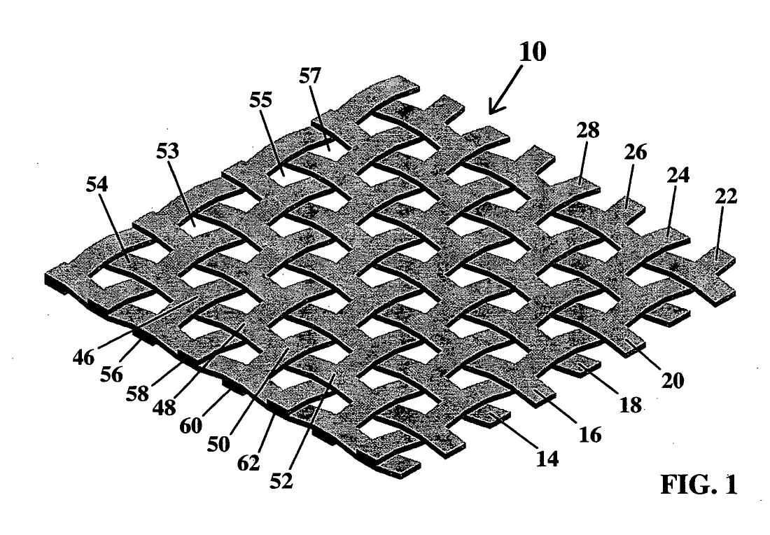

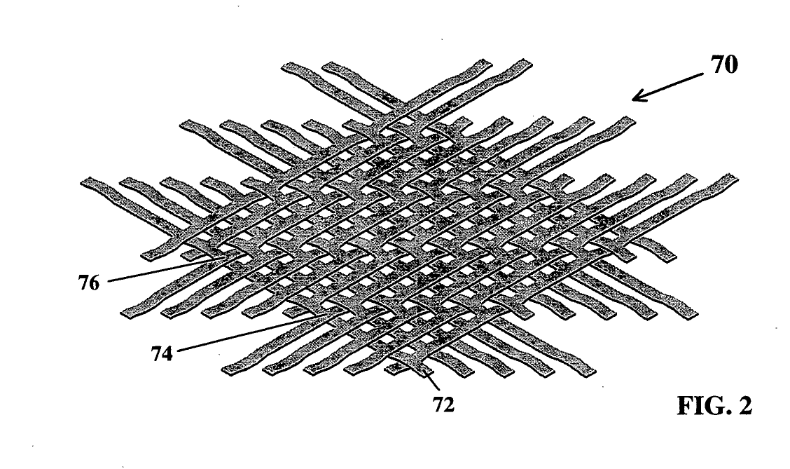

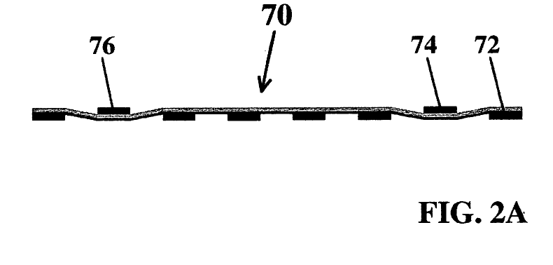

Referring now to the drawings and, more particularly to FIG. 1, there is shown screen 10 that may be utilized for improved filtering characteristics and/or for longer lasting vibrating shaker filter assemblies. Screen 10 is woven with planar surfaced members such as filaments, wires or the like. Screen 10 may also employ different weaves and openings. As used herein, terms such as filaments, wires, and/or other planar members comprise terminology that may be utilized substantially interchangeably. When discussing screen 10 of FIG. 1, it will be understood that other screens shown in FIG. 2-10A may be much more suitable for a particular application than screen 10. Discussion of features of screen 10 will therefore be understood to include other screens disclosed and referred to herein and screen 10 may not be the most suitable screen for use in any possible application. For instance a five-heddle, flat top weave with various types of planar elements discussed hereinafter may be much more suitable for a particular application than screen 10.

Screen 10 utilizes planar surfaced members such as filaments 14, 16, 18, and 20 in a first direction, which may comprise parallel shute filaments. In a preferred embodiment the wires or filaments in one direction will be substantially identical, but depending on the equipment utilized for weaving, may not always be so. Generally, warp filaments are those that go along the length of the weave and shute filaments are those that go sideways with respect to the length of the weave.

Applicants believe that the round shape of the filaments or wires in the mesh or cloth, and the rounded shape of the knuckles, combine to form relatively sharp, almost point contact surfaces between the support or backing screen and the one or more layers of finer mesh screen. The screen of the present invention greatly reduces such friction for reasons discussed hereinbelow.

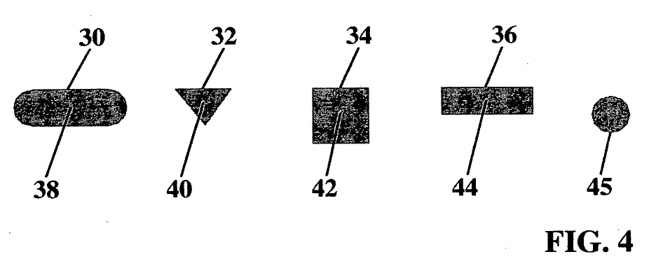

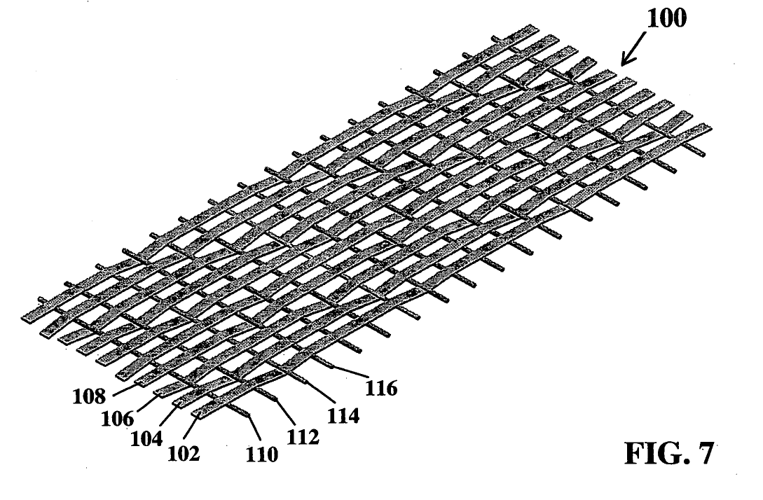

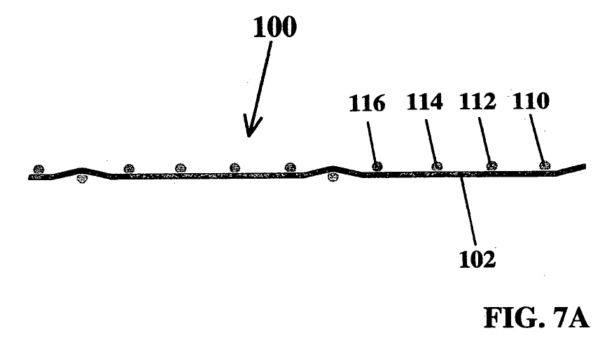

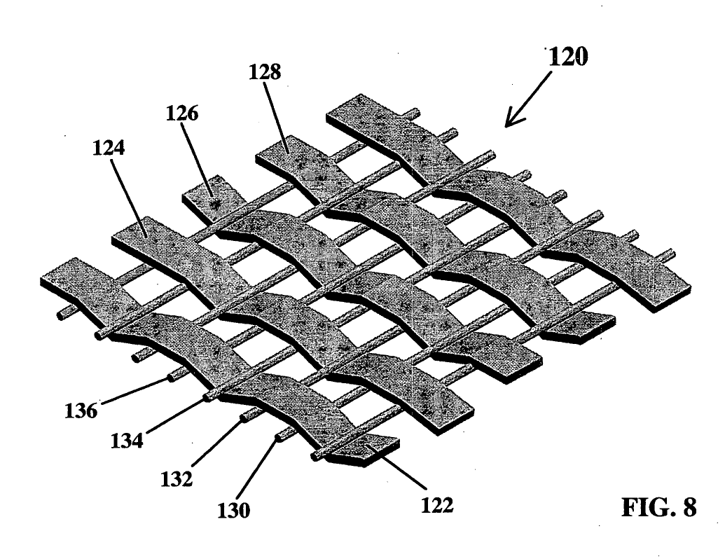

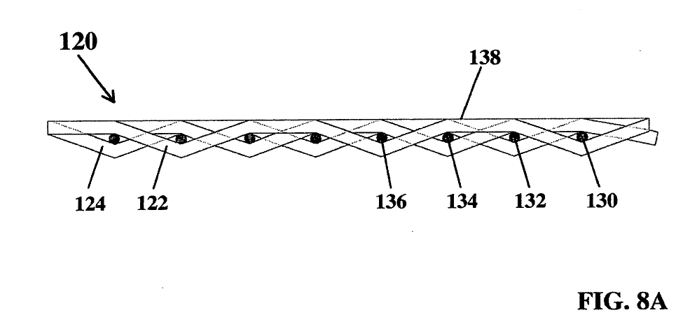

The cross-directional planar surface members or filaments, such as planar surface members 22, 24, 26 and 28, woven transverse to the first direction, may be the parallel warp filaments. In the example of FIG. 1, the warp wires and the shute wires are all identical. However, screen 10 could also be woven with a different cross-sectional types of planar surfaced members or filaments, such as, for example any of those cross-sectional types shown in FIG. 4. Some examples of screens woven with different types of wires, e.g., flat wires and round wires, are shown in FIG. 7-FIG. 8. Thus, screen 10 could be woven with a combination planar and non-planar cross-sectional type members or filaments. For instance, planar wires may be woven with round cross-sectioned wires. Planar wires may also be woven with different cross-sectioned planar wires, e.g., rectangular cross-sectioned planar wires with triangular cross-section planar wires.

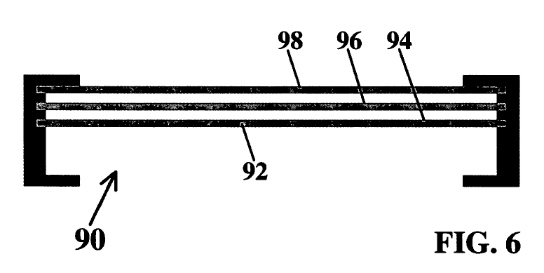

In any case, the planar surface of the members, such as planar surfaces 30, 32, 34, and 36 in FIG. 4, of respective members such as filaments 38, 40, 42, and 44, provide more contact surface area than round cross-sectional members, wires, or filaments. The planar surfaces will preferably be oriented in a specific position in the weave. For instance, in a presently preferred embodiment, the planar surface of interest, such as planar surfaces 30, 32, 34, and/or 36, are oriented so as to be substantially parallel, with slight variations, to the surface of the mesh, and preferably thereby form the surface of the mesh. For some types of weaves, the variations produced by the intersections are greatly reduced by reducing the height of intersections to the extent that one side of the weave may effectively have no knuckles. It is presently theorized that the greater area of contact spreads or distributes the contact forces over a larger surface. Screen 10 has reduced height intersections at each intersection, such as intersections 46, 48, 50, and 52, and the intersections do not make point contact with other screens. The height of intersections 46, 48, 50, and 52 is reduced because the crisscrossed members between member or filament 54 and other members such as filaments 56, 58, 60, or 62, at respective intersections are each recessed in opposite directions. Testing indicates that screen assemblies, such as the screen assembly 90 shown in FIG. 6 that utilize screens with planar wires, such as screen 10 or other types of screens discussed herein, have greater resistance to tearing than prior art screens.

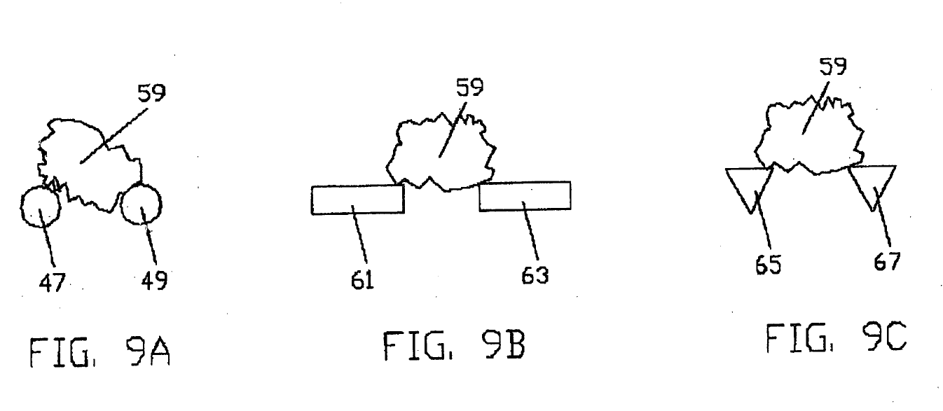

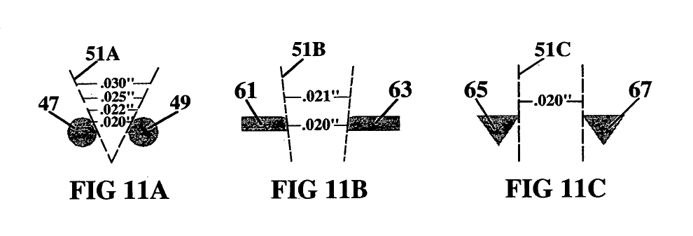

As well, the filtering characteristics of woven planar wire screens is significantly improved due to the effect of the planar surfaces as illustrated in FIG. 9A-9C and FIG. 11A-11C. The wire screen woven with planar filaments tends to blind the screen or clog less as compared to screens woven with round wire. This will be understood in that each receptor or hole produced by round wires, such as round wires 47 and 49 shown in FIG. 9A and FIG. 11A, varies in diameter with thereby permitting larger particles 59 to enter but, then becoming wedged in position as the diameter of the hole decreases with depth thereby blinding or blocking the screen. On the other hand woven planar filament mesh or cloth, such as planar filaments with a rectangular cross-section, have receptors, holes, or apertures, such as apertures 53, 55, and 57 of FIG. 1, as shown in FIG. 9B and FIG. 11B with rectangular planar wires 61 and 63, that have a more constant diameter opening, and therefore either permit an item to go in initially or not. FIG. 9C and FIG. 11C shows triangular wires 65 and 67 that also has as good or somewhat better de-blinding capabilities than those utilizing planar wires 61 and 63. In other words, the angle attributes of the various angles produced by the planar members can provide better significantly improved de-blinding characteristics as compared to a mesh formed with round wires.

As an example, assume the smallest opening in FIG. 11A-11C is 0.020 inches. Then assume that a particle, such as particle 59, in FIG. 9A-9C has dimensions ranging from 0.022 inches to 0.025 inches. Theoretically, the particle should not go through the 0.020 inch openings of FIG. 11A through 11C. However, due to the curved surface of round wires 47 and 49, the initial opening may be in the range of about 0.030 inches and only at the smallest portion is 0.020 as indicated by the dashed angle lines 51A. The problem is that a particle with a size ranging from 0.022 to 0.025 inches has a chance to initially enter and become lodged between the round wires 47 and 49 due to the curved surface of the wires. This eventually blinds or clogs the screen.

In FIG. 9B, the curved opening range is dramatically reduced as indicated by dashed line 51B which may possibly range, in this example, from about 0.020 inches to 0.021 inches. Thus, the particle does not initially enter the opening and the particle's chance of becoming lodged or stuck is decreased substantially. The oversized particle has a much better chance of being rejected as an oversized particle rather than becoming lodged and blinding the screen.

In FIG. 9C, the opening does not really vary at all as indicated by dashed lines 51C and therefore provides an optimal opening. The goal is to move the oversized particles off the screen as quickly as possible. With round wires the particle is constantly trying to go through the screen due to the initially larger opening formed by the curved surface of the round wires. This eventually causes blinding. With planar wires, the curved surfaces are substantially reduced and therefore encourage the particle to move over the top of the screen at a faster rate and reduce screen blinding.

Thus, the present invention may be utilized as a filtration member to filter media, substances, materials, such as, but not limited to, liquids, solids, liquid and solids, solids and solids, gasses, gas-liquid-solids, or any other filtration combination as desired. The terms media, substances, and materials, as used herein, are interchangeable. The top surface of a wire mesh woven with planar filaments has reduced friction and may feel smooth as compared to a wire mesh. The filaments at the intersections remain flexible to increase filtration during vibration while providing a relatively flat, low friction, surface on the top of the woven mesh. The aperture size can be adjusted to the particular filtering application and function required. For instance, if screen 10 or other screens shown in other figures such as for instance FIG. 7, is a support screen for other finer filter screens, then the size of apertures 53, 55, and 57 will be adjusted to permit a larger flow and, perhaps, to filter large particles, materials, or cuttings, as desired. On the other hand, if the screen is to be a finer filter screen, then the maximum particle size to be passed may be utilized as the size of the apertures.

It will be understood that in accord with the present invention, planar surfaced wires such as members or filaments 14, 16, 18, 20 already have a planar surface prior to being woven into vibration resistant screen 10 or the other screens shown in FIG. 2-10. The present invention does not contemplate calendaring a screen already woven from round filaments in order to produce the present invention. On the other hand, calendaring a screen that is woven from planar surfaced members after they are woven together, although not presently considered necessary or perhaps even desirable, would nonetheless be in accord with the invention if the screen is initially woven with planar members such as planar filaments and planar wires or other woven planar flexible members. Thus, one feature of the present invention that produces a vibration resistant screen is filaments or wires that are planar-surfaced prior to weaving. One method of the invention involves forming a vibration resistant screen by weaving planar surfaced filaments together.

While the intersections of screen 10 result in less tearing, abrasion, and/or friction producing action than those of prior art screens, it is also possible to reduce the effect or thickness of the intersections, and so reduce the friction even further by utilizing different types of weaves. In a presently preferred embodiment, screen 70 as shown in FIG. 2 and from the side in FIG. 2A may therefore utilize a five-heddle weave to thereby effectively eliminate the knuckles on one side and also reduce the number of crossing intersections that could produce knuckles. For a typical row 72, intersections such as intersections where the wires change position such as at 74 and 76 occur only every fifth planar element or filament on one side. The level of the planar surface of the weave of one side is very uniform. Utilizing the planar surfaced filaments also results in a flatter intersection where the wires change levels so as to effectively eliminate knuckle effects as most clearly shown in FIG. 2A while the strength and metal content of the wire may be substantially the same. The casual observer, when feeling a mesh woven with round filaments and comparing that with a mesh woven with planar elements, will immediately notice the reduction in friction. Planar surfaces of filaments produce “plate” like surfaces versus round wires which feel much rougher.

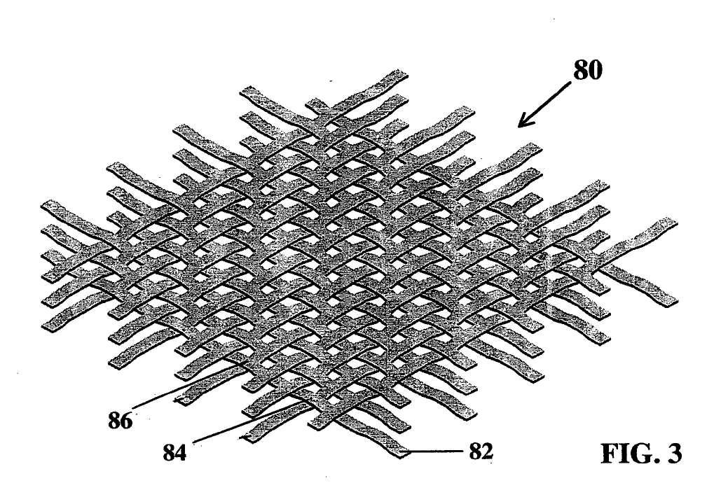

Other heddle weaves could also be utilized with more or fewer intersections per row. For instance, intersections where the wires change levels in a row could be spaced by every 2nd-4th planar element in a heddle weave. As another example, the reduced diameter knuckles could be spaced apart by more than five elements or filaments in a heddle weave, and may effectively result in zero knuckles. Screen 80 of FIG. 3 shows a three-heddle weave whereby in row 82, reduced diameter knuckles 84 and 86 are spaced every three filaments. Other types of suitable weaves for planar elements or filaments, a few possibilities of which are shown hereinafter, include twill, plain, Dutch weave, twill weave, lock crimped, ride lockcrimped or flat top, weaving combinations, other weaves, and so forth.

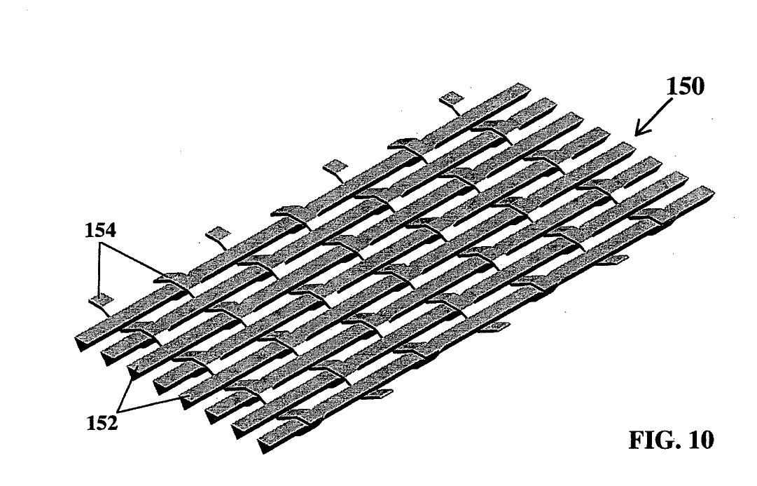

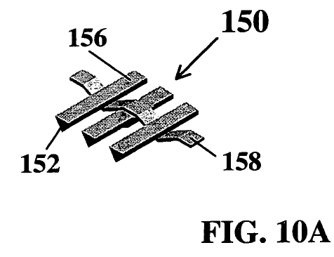

FIG. 4 shows cross-sections of various types of members, wires, filaments, and the like that may be utilized in a woven screen, mesh, or cloth in accord with the present invention. Wire cloth according to the present invention can utilize various cross-sectional wires, filaments or members in the warp directions such as wire 45 which as a round cross-section, square cross-section wire 42, rectangular cross-section wire 44, triangular cross-section wire 40, elliptical cross-section wire 38, or other specialty shape. Terms such as mesh, cloth, and screen are used interchangeably herein. Likewise shute wire may include the above shapes. By planar members it is meant herein that at least one surface of the wire, member, or filament contains a plane. A plane is capable of having three points, or a straight line, in a two-dimensional surface. Thus, the planar wires have a flat surface on which a straight line joining any two points would wholly lie. Due to the slight variations caused by the knuckles or intersections where the wires change relative height position in the mesh, the straight line may generally need to be transverse to the length of the wire at any point along the length to more accurately describe, geometrically, a planar wire in accord with the present invention. A round cross-sectional filament or wire, such as wire 45, does not provide this. Another way to say this is that the member, filament, or wire has a flat side that is uniform along its length. Thus, the shape of the cross-section will preferably be continuous along the length of the member, filament, or wire. Thus, calendaring an already woven screen will not produce planar members as discussed herein, because calendared filaments or wires do not have substantially the same cross-section along their length. Instead, calendaring will produce variations in the cross-sections of the wires or filaments at the knuckles. Moreover, the present invention, as discussed above, utilizes planar members such as filaments or wires that are planar prior to being woven together. However, one presently preferred embodiment of screen 150, shown in FIG. 10 and FIG. 10A, utilizes a flat top weave with a combination of triangular cross-sectioned wires 152 and rectangular cross-sectioned planar wires 154, may preferably provide that planar wires 154 are pre-crimped.

The particular type of planar wire cross-section in accord with the present invention may be produced in various ways, such as with an extruder to produce the desired cross-section, or by utilizing other flattening means prior to weaving. Thus, planar filaments, wires, or elongate weavable members may be produced in any suitable manner whereby they are planar prior to being woven into a screen in accord with the present invention.

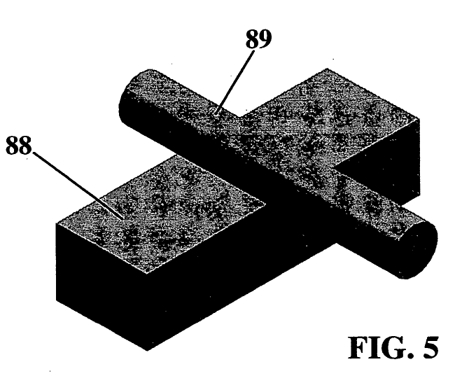

As indicated in FIG. 5, different shapes may be utilized in different directions. For instance, rectangular cross-sectional filament 88 may be utilized with round cross-sectional filament 89. However, any cross-sectional type may be used with another cross-sectional type as desired in accord with the present invention, for shute and warp filaments, so long as at least one type of filament includes a planar surface prior to weaving. Generally, it may be desirable that all shute wires be of the same cross-sectional construction and all warp wires be of the same cross-sectional construction. However, this depends only upon any limitations of the weaving equipment and therefore weaving equipment may be utilized that permits usage of different cross-sectional types in the shute or the warp wires, as desired. The size, diameters, and widths of the filaments and the spacings and dimensions between the shute filaments and the warp filaments may also be varied as desired.

FIG. 6 shows one example of a filtration system 90 in accord with the present invention which may by utilized as a vibrating screen. Many different constructions of a filtration system, such as filtration system 90, are possible utilizing wire screens, cloth or mesh woven with planar filaments, wires, or members, in accord with the present invention. A screen such as woven screens 10, 70, or 80, or other screens as discussed herein, may be utilized as either a back up member or a support member or may be utilized as filtration material, or both, or may be utilized with other layers of filtration material which may or may not also include screens woven with planar filaments, wires, or other flexible planar members.

Thus, the planar wire screen may or may not be utilized as a support positioned at 92 for supporting other screens. However, the overall assembly in accord with the present invention will utilize at least one screen woven with planar members. Any number of other meshes may be supported at one or more other positions. For instance, a different screen may be utilized at each of positions 94, 96, and/or 98. Each of the screens at 94, 96, or 98 may or may not include woven planar wires. Thus, the mesh woven with planar members of present invention can be utilized in any desirable configuration with any other types of screens, or alone, or with one or more other screens woven with planar members. The screens 92-98, may be affixed together, if desired, using any suitable means such as being bonded together with plastic or other materials, or may comprise a releasable combination of screens wherein each screen may be replaced as desired.

Moreover, the woven planar filament meshes of the present invention may be molded into other shapes, which may not be flat, or which may be pleated or rounded, and may be utilized in any desirable shape within any type of filtration equipment which may not utilize vibration but may also utilize pressure or other means of filtration.

Some additional possible variations of the present invention are shown in FIG. 7-FIG. 9. However, it will be understood from review of the disclosure of the present invention that many different types of weaves and combinations utilizing woven planar members in accord with the present invention may be utilized.

FIG. 7 shows a perspective view of a five-heddle weave mesh 100 wherein planar members such as planar filaments or planar wires 102, 104, 106, 108, etc. are utilized in one direction and round members such as round filaments or round wires 110, 112, 114, 116, and so forth, are utilized in another direction. A side view of this configuration is shown in FIG. 7A. The relatively flat surface 102 and effectively eliminated knuckles of the heddle weave is illustrated once again from the side view of FIG. 7A whereby friction at surface 102 is greatly reduced as compared to the same weave or other weaves utilizing only round wires.

FIG. 8 shows another screen or mesh 120 in accord with the invention utilizing a twilled weave wherein planar members such as planar filaments or planar wires 122, 124, 126, 128, and so forth, are woven in one direction in the screen or mesh. Round filaments or round wires 130, 132, 134, 136, and so forth, are utilized in the orthogonal or perpendicular direction. As can be seen from the side view of FIG. 8A, the composite upper surface 138 of screen or mesh 120 has a relatively flat profile, thereby providing reduced friction.

FIG. 10 is a perspective view of screen 150 which utilizes triangular wires 152 and flat planar wires 154 in a flat top weave. FIG. 10A shows screen 150 from the side to more clearly illustrate the flat upper surface 156. Moreover, it will be seen that in a presently preferred embodiment, planar flat planar wires are preferably pre-crimped as indicated at 158 to thereby mate better with triangular cross-sectioned wires 152. Screen 150 provides excellent de-blinding properties as well as low friction at upper surface 156. Thus, screen 150 may be utilized in screen assemblies for support purposes and/or for improved filtering characteristics. As well, screen 150 may be utilized by itself as desired for filtering purposes.

The woven planar wires may be comprised of fibers of various types, stainless steel, carbon steel, other metallic materials, combinations thereof, plastics, or any other suitable material. A screen in accord with the present invention should be woven. One advantage of woven screens is a built-in resistance against vibration because the single wires are free to move with respect to each other. This effect also improves the filtering characteristics.

Thus, the foregoing disclosure and description of the invention is therefore illustrative and explanatory of one or more presently preferred embodiments of the invention and variations thereof, and it will be appreciated by those skilled in the art that various changes in the design, organization, order of operation, means of operation, equipment structures and location, methodology, and use of mechanical equivalents, as well as in the details of the illustrated construction or combinations of features of the various elements, may be made without departing from the spirit of the invention. As well, the drawings are intended to describe the concepts of the invention so that the presently preferred embodiments of the invention will be plainly disclosed to one of skill in the art but are not intended to be manufacturing level drawings or renditions of final products and may include simplified conceptual views as desired for easier and quicker understanding or explanation of the invention. It will be seen that various changes and alternatives may be used that are contained within the spirit of the invention. Moreover, it will be understood that various directions such as “upper,” “lower,” “bottom,” “top,” “left,” “right,” “inwardly,” “outwardly,” and so forth are made only with respect to easier explanation in conjunction with the drawings and that the components may be oriented differently, for instance, during transportation and manufacturing as well as operation. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

1. A screen assembly for filtering media, said screen assembly comprising:
a first plurality of planar wires, said first plurality of planar wires being formed so as to have a cross-section with at least one planar surface, said at least one planar surface extending substantially along the length of said first plurality of planar wires prior to being woven;
a second plurality of wires, said first plurality of planar wires being interwoven with a second plurality of wires to form a first screen, said at least one planar surface being continuous along each of said first plurality of planar wires; and
at least one additional screen secured to but not interwoven with said first screen.

2. (canceled)

3. The assembly of claim 1, wherein said first plurality of planar wires are oriented in said first screen such that said at least one planar surface of said plurality of planar wires thereby forms at least a portion of said surface of said first screen.

4. The assembly of claim 3, wherein said first plurality of planar wires and said second plurality of wires intersect with respect to each other at intersections, said first plurality of planar wires has portions between said intersections where said at least one planar surface of said fist plurality of planar wires is substantially parallel to said surface of said screen wire.

5. The assembly of claim 1, wherein said second plurality of wires have a cross-section with a second planar surface.

6. The assembly of claim 1, wherein said second plurality of wires have a triangular cross-section.

7. The assembly of claim 1, wherein said second plurality of wires have a round cross-section.

8. The assembly of claim 1, wherein said first screen is mechanically stronger than said at least one additional screen and supports said at least one additional screen.

9. (canceled)

10. (canceled)

11. (canceled)

12. (canceled)

13. A screen filtration assembly for filtering one or more materials, comprising:
a first plurality of planar wires, said first plurality of planar wires being formed with one or more planar surfaces substantially along their length prior to being woven; and
a second plurality of wires, said first plurality of planar wires being interwoven with respect to said second plurality of wires to form a first screen, said first screen having a first surface with a first plurality openings therein between a plurality of intersections formed by said first plurality of planar wires and said second plurality of wires, said openings being sized to perform a filtering function with respect to said one or more materials to be filtered; and
at least one additional screen secured to said first surface of said first screen but not interwoven with said first screen.

14. (canceled)

15. The assembly of claim 13, wherein said at least one additional screen is formed with a second plurality of openings, said second plurality of openings being finer than said first plurality of openings, said first screen being mechanically stronger than said second screen to provide a support for said second screen.

16. The assembly of claim 13, wherein at least one additional screen is formed with a second plurality of openings, said second plurality of openings being coarser than said first plurality of openings and said at least one additional screen being mechanically stronger than said first screen to provide a support for said first screen.

17. The assembly of claim 13, wherein said first plurality of planar wires have a triangular cross-section.

18. The assembly of claim 13, wherein said second plurality of wires have a round cross-section.

19. The assembly of claim 13, wherein said second plurality of wires have a cross-section with a planar surface.

20. The assembly of claim 13, wherein said first plurality of planar wires each have a different cross-sectional shape than said second plurality of wires.

21. The assembly of claim 13, wherein said first plurality of planar wires each have an identical cross-sectional shape as compared to said second plurality of wires.
